(19) United States
(12) Patent Application Publication
(10) Pub. No.: US 2016/0188556 A1
(43) Pub. Date: Jun. 30, 2016

(54) ADAPTIVE ELECTRONIC DOCUMENT

(71) Applicant: Alibaba Group Holding Limited, Grand Cayman (KY)

(72) Inventor: Yun Li, Hangzhou (CN)

(21) Appl. No.: 14/977,215

(22) Filed: Dec. 21, 2015

(30) Foreign Application Priority Data
Dec. 24, 2014 (CN) 201410817706.7

(51) Int. Cl. G06F 17/24; G06F 17/30

(52) U.S. Cl. CPC G06F 17/24; G06F 17/30896

(57) ABSTRACT

The present disclosure relates to the technical field of digital reading and digital publishing, and particularly to an adaptive electronic document file structure and corresponding method and apparatus, wherein the adaptive electronic document file structure includes a content part and a logic part; the content part includes content of an electronic document and a style corresponding to each piece of content; the logic part includes a decision logic for matching corresponding content with a style corresponding to such content according to different application environments. The present techniques solve the problem of personalized and adaptive reading for different devices, environments and readers in terms of an one-time production and publication of the content of an electronic document, which greatly improves the flexibility and design freedom for electronic document creators, and makes it possible for a reader device to provide a personalized reading service more intelligently and accurately.

### CROSS REFERENCE TO RELATED PATENT APPLICATION

This application claims foreign priority to Chinese Patent application No. 201410817706.7 filed on 24 Dec. 2014, entitled “Adaptive Electronic Document File Structure, and Related Method and Apparatus,” which is hereby incorporated herein by reference in its entirety.

### TECHNICAL FIELD

The present disclosure relates to the technical field of digital reading and digital publishing, and, more particularly, to an adaptive electronic document file structure and corresponding methods and apparatuses.

### BACKGROUND

The document format of an electronic document or e-book mainly includes two types: fixed layout and fluid layout. The former designs the layout and edits the content according to a fixed size. The latter only describes the sequence and style of the content, and designs the layout upon presentation.

The Common e-Document of Blending XML (CEBX) format includes both fixed-layout and fluid-layout descriptions. The fixed-layout description may include device selection information. The fixed-layout or fluid-layout presentation form is selected according to a screen size.

The conventional techniques have at least the following technical problems:

An electronic document produced by using a unified standard or style usually cannot be presented on different devices perfectly. Furthermore, when preparing multiple documents for different users and devices, there will be various problems with maintenance and synchronization. CEBX and ePub include an adaptive description with respect to the reading device feature and functional support, but their applicability and extensibility have shortcomings.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “technique(s) or technical solution(s)” for instance, may refer to apparatus(s), system(s), method(s) and/or computer-readable instructions as permitted by the context above and throughout the present disclosure.

An objective of the example embodiments of the present disclosure is to provide an adaptive electronic document file structure and corresponding method and apparatus to solve the problem in the conventional techniques that an electronic document provider cannot provide a corresponding content and style of an electronic document according to application environments of different readers, which results in a poor reader experience.

To solve the above technical problem, an example embodiment of the present disclosure provides an adaptive electronic document file structure including a content part and a logic part.

The content part includes various pieces of content of an electronic document and a style corresponding to each piece of content. The logic part includes a decision logic that matches a piece of content with a style corresponding to the piece of content according to different application environments.

To solve the above technical problem, an example embodiment of the present disclosure further provides an adaptive electronic document generation method, which includes the following operations:

producing various pieces of content of an electronic document and a style corresponding to each piece of content; and

editing a decision logic that matches the piece of content with a style corresponding to the piece of content according to different application environments.

To solve the above technical problem, an example embodiment of the present disclosure further provides an adaptive electronic document generation apparatus, which includes:

a content and style production unit that produces various pieces of content of an electronic document and a style corresponding to each piece of content; and

a feature logic edition unit that edits a decision logic that matches the piece of content with a style corresponding to the piece of content according to different application environments.

To solve the above technical problem, an example embodiment of the present disclosure further provides an adaptive electronic document reading method, which includes the following operations:

collecting application environment information;

parsing a decision logic that matches a piece of content with a style corresponding to the piece of content according to different application environments in an electronic document;

implementing the decision logic according to the decision logic and the application environment information; and

presenting, according to a result of the decision logic, corresponding piece of content and a style corresponding to the piece of content in the electronic document.

To solve the above technical problem, an example embodiment of the present disclosure further provides an adaptive electronic document reading terminal, which includes:

a collection unit that collects application environment information;

a parsing unit that parses a decision logic that matches a piece of content with a style corresponding to the piece of content according to different application environments in an electronic document;

a decision logic unit that implements the decision logic according to the decision logic and application environment information; and

a presentation unit that presents, according to a result of the decision logic, corresponding piece of content and a style corresponding to the piece of content in the electronic document.

To solve the above technical problem, an example embodiment of the present disclosure further provides an adaptive electronic document server, including:

a collection unit that collects application environment information;

a parsing unit that parses a decision logic that matches a piece of content with a style corresponding to the content according to different application environments in an electronic document;

a decision logic unit that implements the decision logic according to the decision logic and the application environment information; and

an output unit that sends, according to a result of the decision logic, corresponding piece of content and a style corresponding to the piece of content in the electronic document to a reading terminal for presentation.

As shown from the technical solutions provided in the example embodiments of the present disclosure, in the production of an electronic document, different branches are defined according to different application environments and various logical relationships, and in such branches, corresponding content and style are described and presented. When presenting an electronic document, a reading device parses a decision logic and makes a logic determination according to personalized information of a reader and attribute information of a reading terminal and general attribute information. The reading device selects an optimal branch, presents the content or presents corresponding content according to a specified style, and supports a specified interaction mode. The techniques of the present disclosure solve, to some extent, the problem of personalized and adaptive reading for different devices, environments and readers in terms of a one-time production and publication of the content of an electronic document, and greatly improve the flexibility and design freedom for electronic document creators, and make it possible for a reader device to provide a personalized reading service more intelligently and accurately.

Certainly, it is not necessary for any product or method implementing the present disclosure to achieve all of the above advantages simultaneously.

### BRIEF DESCRIPTION OF THE DRAWINGS

In order to explain technical solutions of the example embodiments of the present disclosure clearly, a brief introduction of drawings is used below for describing the example embodiments. Apparently, the drawings described below merely represent some example embodiments of the present disclosure, and other drawings may be obtained according to these drawings by those skilled in the art without using creative labor.

FIG. 1 is a schematic diagram of an example adaptive electronic document file structure according to an example embodiment of the present disclosure;

FIG. 2 is a flowchart of an example adaptive electronic document generation method according to an example embodiment of the present disclosure;

FIG. 3 is a structural diagram of an example adaptive electronic document generation apparatus according to an example embodiment of the present disclosure;

FIG. 4 is a flowchart of an example adaptive electronic document reading method according to an example embodiment of the present disclosure;

FIG. 5 is a schematic structural diagram of an example adaptive electronic document reading terminal according to an example embodiment of the present disclosure;

FIG. 6 is a schematic structural diagram of an example adaptive electronic document server according to an example embodiment of the present disclosure;

FIG. 7 is a flowchart of example processing an adaptive electronic document by a reading terminal according to an example embodiment of the present disclosure; and

FIG. 8 is a flowchart of example processing an adaptive electronic document by a server according to an embodiment of the present disclosure.

### DETAILED DESCRIPTION

The example embodiments of the present disclosure provide an adaptive electronic document file structure and corresponding method and apparatus.

To make the technical solutions of the present disclosure more comprehensible to those skilled in the art, the technical solutions in the example embodiments of the present disclosure are described as follows with reference to the accompanying drawings in the example embodiments of the present disclosure. Apparently, the example embodiments to be described merely represent a part and not all of the embodiments of the present disclosure. All other embodiments obtained by persons of ordinary skill in the art based on the example embodiments of the present disclosure without creative efforts shall belong to the protection scope of the present disclosure.

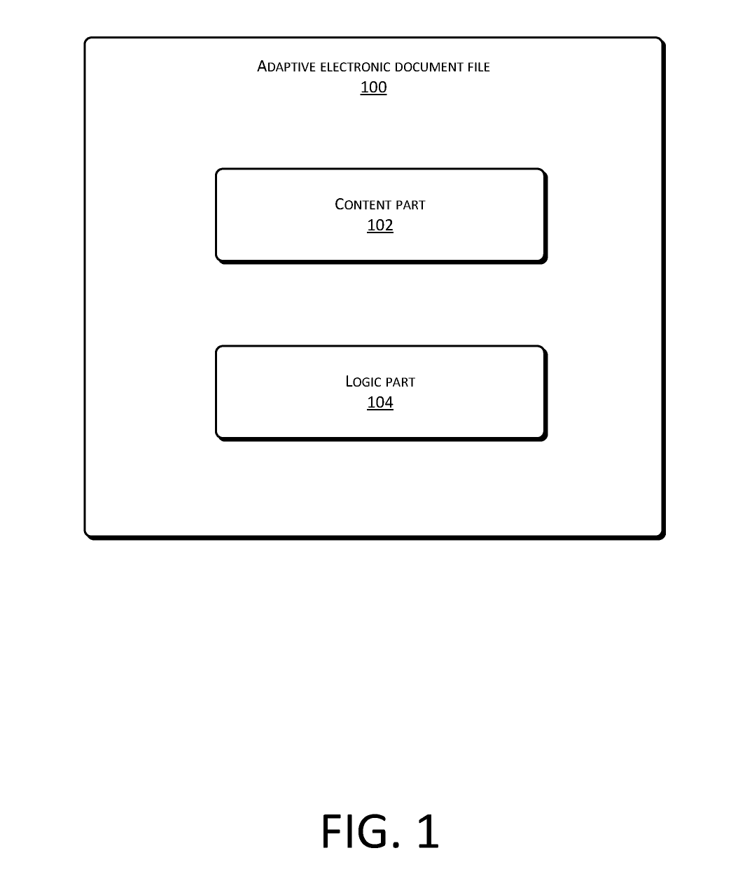

FIG. 1 is a schematic diagram of an example adaptive electronic document file structure according to an example embodiment of the present disclosure.

An adaptive electronic document file 100 includes a content part 102 and a logic part 104.

The content part 102 includes multiple contents of an electronic document and styles, each style corresponding to a respective content of the multiple contents.

The logic part 104 includes a decision logic for matching corresponding content with a style corresponding to the content according to different application environments, wherein the content may correspond to multiple styles or one style.

According to an example embodiment of the present disclosure, the application environment includes personalized information of a reader, and/or attribute information of a reading terminal, and/or general attributes.

According to an example embodiment of the present disclosure, the personalized information of the reader includes, but is not limited to, age, location, gender, reading preferences, income and the like of the reader. The attribute information of the reading terminal includes, but is not limited to, a type (mobile phone, tablet, or the like), resolution, dimension, computation capability (CPU), storage capability (memory), network type used, interactive support, and the like of the reading terminal. The general attributes include, but are not limited to, date, time, motion status of the device, light and location of an environment where the device is located, and the like.

According to an example embodiment of the present disclosure, the style includes, but is not limited to, a form, color, text, image zooming scale, display direction and the like of the displayed content, which also includes a supported interaction mode and the like.

According to an example embodiment of the present disclosure, the logic part 104 further includes a parameter that represents the application environment, and a decision logic expression formed by the parameter. For example, the age in the personalized information of the reader is represented by a parameter AGE, and the logic expression may be “if AGE>18 then display content B02 in style A01”, which indicates that if the reader is older than 18 years, the content “B02” will be displayed in the style “A01.” The logic part 104 is a part of the electronic document. Those skilled in the art should understand that the kind of parameters may be used to represent the application environment is optional, which is not limited by the present disclosure, and the logic expression may be in varied forms. The above logic expression is provided for illustration only, and should not be construed as limiting the implementation of the present disclosure.

According to an example embodiment of the present disclosure, a logic branch of the decision logic expression includes a reference identifier that represents content and a style corresponding to the content; or includes specific data of content and a style corresponding to the content, wherein the reference identifier includes an index number that indicates the paragraph or chapter of the displayed content, a serial number that indicates the style of the displayed content, and the like. For example, 01 represents the 1^{st} paragraph, and 02 represents the 2^{nd} paragraph of the content. Specific data of the content and style may be specific content generated in a specific style. With respect to the form of the reference identifier in the example embodiment, for example, the decision logic expression is if (AGE>18) then [display paragraph 01] else [display paragraph 02], which indicates that if the reader is older than 18 years, a paragraph with a paragraph identifier of 01 will be displayed, otherwise, a paragraph with a paragraph identifier of 02 is displayed; the decision logic expression is if (gender=male) then [display paragraph 01 in style B1] else [display paragraph 01 in style B2], which indicates that if the reader is a male, the paragraph 01 will be displayed in the style B1, otherwise, the paragraph 01 is displayed in the style B2, wherein B1 is in blue and Simsun font, and B2 is in pink and KaiTi font. With respect to the form of specific data in the example embodiment, for example, the decision logic expression is if (AGE>18) then [specific content data of the first paragraph of article] else [specific content data of the second paragraph of article], which indicates that if the reader is older than 18 years, the specific content of the first paragraph of the article is displayed, such that a paragraph with military content is displayed, otherwise, the specific content of the second paragraph of the article is displayed, such that a paragraph with political content is displayed; the decision logic expression is if (gender=male) then [display specific content data of the first paragraph of article in Blue and Simsun font] else [display specific content data of the first paragraph of article in Pink and KaiTi font], which indicates that if the reader is a male, the specific content of the first paragraph of the article is displayed in Blue and Simsun font, otherwise, the specific content data of the first paragraph of the article is displayed in Pink and KaiTi font.

By using the above adaptive electronic document file structure according to the example embodiment of the present disclosure, the electronic document provider determines content and style of an electronic document for various application environments without using a reader to provide uniform reading content and style to the reader, which brings abundant modes for the electronic document provider to provide diversified electronic documents to the reader, and provides users (electronic document provider and reader) with better experience.

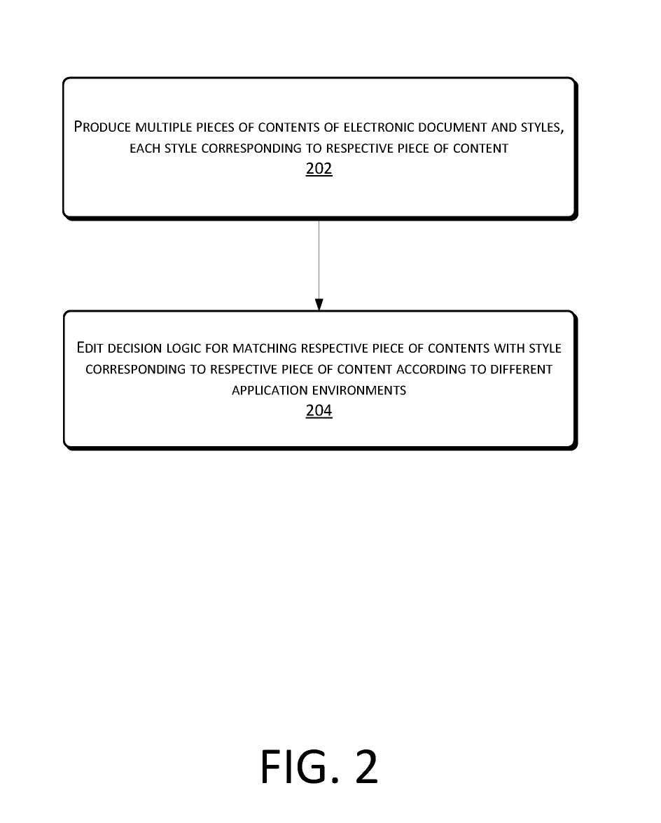

FIG. 2 is a flowchart of an example adaptive electronic document generation method according to an example embodiment of the present disclosure.

The adaptive electronic document generation method shown in FIG. 2 includes operations at 202 and 204.

At 202, multiple pieces of contents of an electronic document and styles are produced, each style corresponding to one piece of content.

At 204, a decision logic for matching a respective piece of content with a style corresponding to the respective piece of content according to different application environments is edited.

According to an example embodiment of the present disclosure, the editing the decision logic further includes editing a parameter that represents the application environment, and forming a decision logic expression by using the parameter.

According to an example embodiment of the present disclosure, a logic branch of the decision logic expression includes a reference identifier that represents content and style; or includes specific data of content and style.

The electronic document is generated according to the content, the style corresponding to each piece of content and the decision logic.

By using the adaptive electronic document generation method of the present disclosure, the electronic document provider generates an electronic document having a decision logic. The electronic document provider provides electronic documents having different contents to different readers, and provides the reader with a style that better conforms to the reader's reading habit, which establishes a service channel between the electronic document provider and reader, and really provides differential reading content and style based on different reader personality, reading devices and environments.

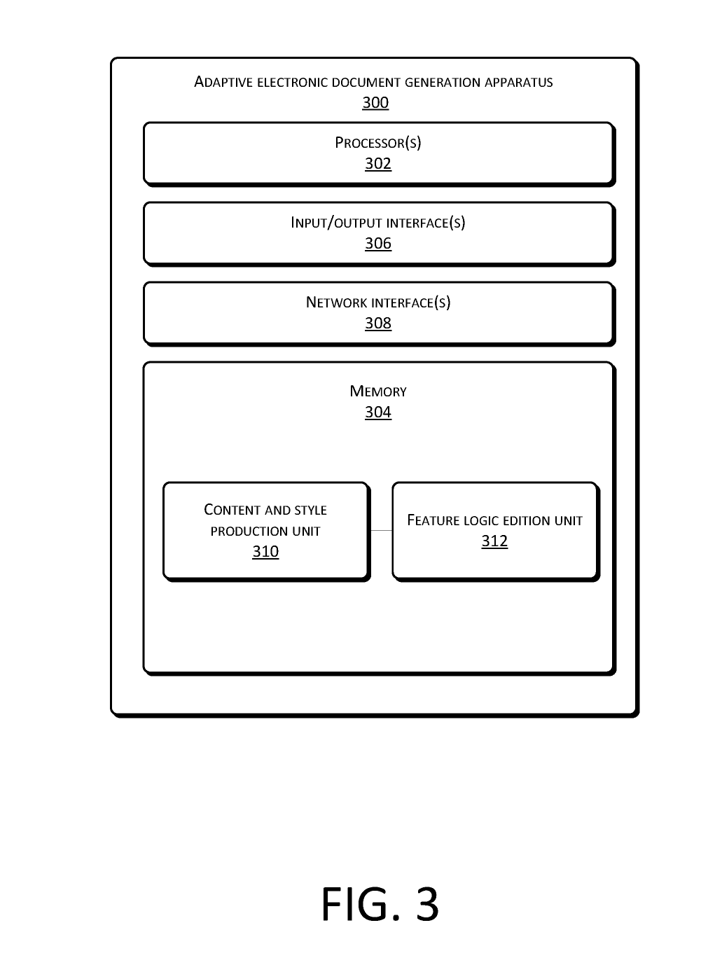

FIG. 3 is a structural diagram of an example adaptive electronic document generation apparatus 300 according to an embodiment of the present disclosure. The adaptive electronic document generation apparatus 300 may include one or more processor(s) 302 or data processing unit(s) and memory 304. The apparatus 300 may further include one or more input/output interface(s) 306, and network interface(s) 308. The memory 304 is an example of computer-readable media.

The computer-readable media includes permanent and non-permanent, movable and non-movable media that may use any methods or techniques to implement information storage. The information may be computer-readable instructions, data structure, software modules, or any data. The example of computer storage media may include, but is not limited to, phase-change memory (PCM), static random access memory (SRAM), dynamic random access memory (DRAM), other type RAM, ROM, electrically erasable programmable read only memory (EEPROM), flash memory, internal memory, CD-ROM, DVD, optical memory, magnetic tape, magnetic disk, any other magnetic storage device, or any other non-communication media that may store information accessible by the computing device. As defined herein, the computer-readable media does not include transitory media such as a modulated data signal and a carrier wave.

The memory 304 may store therein a plurality of modules or units including a content and style production unit 310 that produces various contents of an electronic document and a style corresponding to each piece of content; and a feature logic edition unit 312 that edits a decision logic for matching corresponding content with a style corresponding to the content according to different application environments.

According to an example embodiment of the present disclosure, the feature logic edition unit 312 further edits a parameter that represents the application environment, and forms a decision logic expression by using the parameter.

According to an example embodiment of the present disclosure, a logic branch of the decision logic expression includes a reference identifier that represents content and a style corresponding to each piece of content; or includes specific data of content and a style corresponding to each piece of content.

The content and style production unit 310 and the feature logic edition unit 312 may be implemented by the processor(s) 302.

By using the above adaptive electronic document generation apparatus of the present disclosure, the electronic document provider generates an electronic document having a decision logic. The electronic document provider provides electronic documents having different contents to different readers, and provides the reader with a style that better conforms to the reader's reading habit, which establishes a service channel between the electronic document provider and reader, and really provides reading content and style based on different reader personality, reading devices and environments.

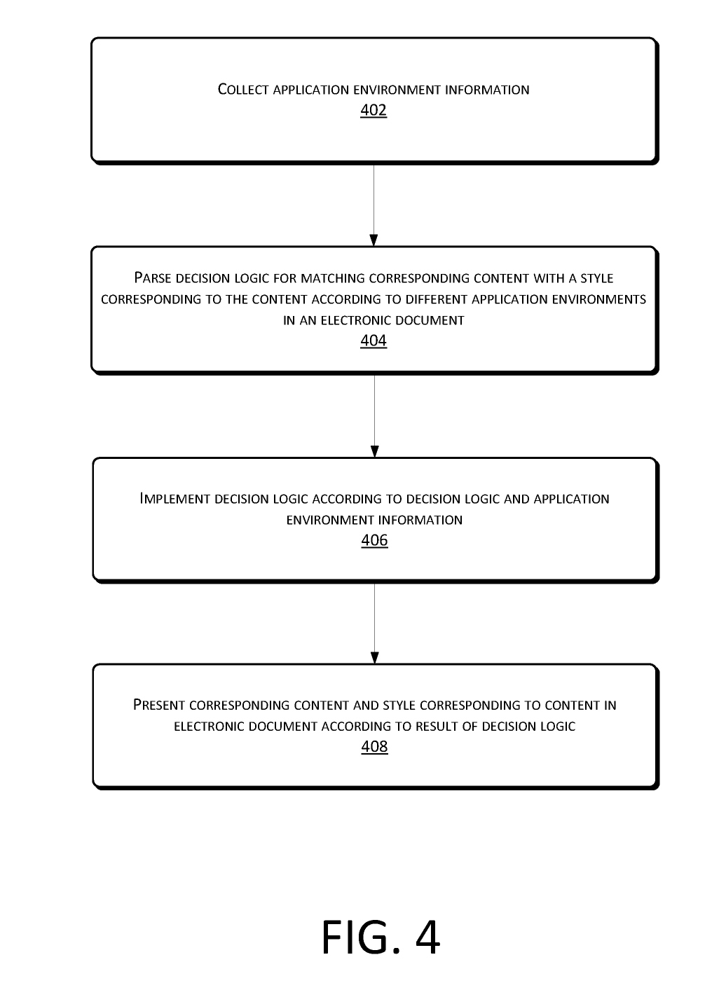

FIG. 4 is a flowchart of an example adaptive electronic document reading method according to an embodiment of the present disclosure, which includes:

At 402, application environment information is collected.

At 404, a decision logic for matching corresponding content with a style corresponding to the content according to different application environments in an electronic document is parsed.

At 406, the decision logic is implemented according to the decision logic and application environment information.

At 408, according to a result of the decision logic, corresponding content and a style corresponding to the content in the electronic document are presented.

According to an example embodiment of the present disclosure, the application environment includes personalized information of a reader, and/or attribute information of a reading terminal, and/or general attributes.

According to an example embodiment of the present disclosure, the personalized information of the reader includes, but is not limited to, age, location, gender, reading preferences, income and the like of the reader; the attribute information of the reading terminal includes, but is not limited to, a type (mobile phone, tablet, or the like), resolution, dimension, computation capability (CPU), storage capability (memory), network type used, interactive support, and the like of the reading terminal; the general attributes include, but are not limited to, date, time, motion status, light, location, and the like.

By using the above adaptive electronic document reading method of the present disclosure, an electronic document that has particular content and style and is matched with the application environment of the reader is provided to the reader according to the decision logic in the electronic document, which improves the reading experience for the reader.

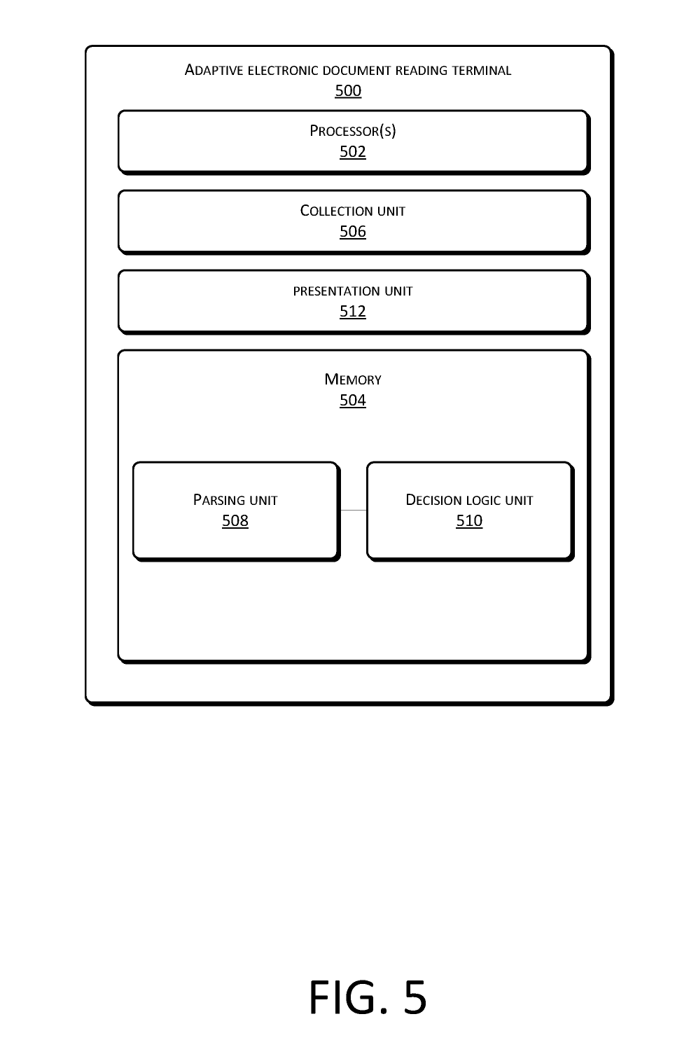

FIG. 5 is a schematic structural diagram of an example adaptive electronic document reading terminal 500 according to an example embodiment of the present disclosure.

The adaptive electronic document reading terminal 500 may include one or more processor(s) 502 or data processing unit(s) and memory 504. The memory 504 is an example of computer-readable media.

The terminal 500 may include the following units:

a collection unit 506 that collects application environment information;

a parsing unit 508, stored on memory 504, that parses a decision logic for matching corresponding content with a style corresponding to the content according to different application environments in an electronic document;

a decision logic unit 510, stored on memory 504, that implements the decision logic according to the decision logic and application environment information;

a presentation unit 512 that presents, according to a result of the decision logic, corresponding content and a style corresponding to the content in the electronic document.

According to an example embodiment of the present disclosure, the application environment includes personalized information of a reader, and/or attribute information of a reading terminal, and/or general attributes.

According to an example embodiment of the present disclosure, the personalized information of the reader includes, but is not limited to, age, location, gender, reading preferences, income and the like of the reader; the attribute information of the reading terminal includes, but is not limited to, a type (mobile phone, tablet, or the like), resolution, dimension, computation capability (CPU), storage capability (memory), network type used, interactive support, and the like of the reading terminal; the general attributes include, but are not limited to, date, time, motion status, light, location, and the like.

The collection unit 506 may be implemented by an input/output interface or sensor of the terminal 500 (such as mobile phone or tablet computer) of the reader. For example, the collection unit 506 may include a touch screen, a microphone, a gravity sensor, a light sensor, and the like. The parsing unit 508 and the decision logic unit 510 may be stored on the memory 504 and implemented by the processors(s) 502 of the terminal 500. The presentation unit 512 may be implemented by using a display component such as a liquid crystal screen, and presents the corresponding content and style in the electronic document, wherein the presentation includes a presentation of displayed color, font, content arrangement, multimedia form, interaction mode and various other audio-visual modes. The interaction mode is a part of the style. For example, style 1 is to click on a Sudoku for an interaction and control, and style 2 is to simulate an icon arrangement of a computer browser for an interaction and click operation. The definition of the presentation in this example embodiment is also applicable to other embodiments.

By using the above adaptive electronic document reading terminal of the present disclosure, an electronic document that has particular content and style and is matched with the application environment of the reader is provided to the reader according to the decision logic for the electronic document, which improves the reading experience for the reader.

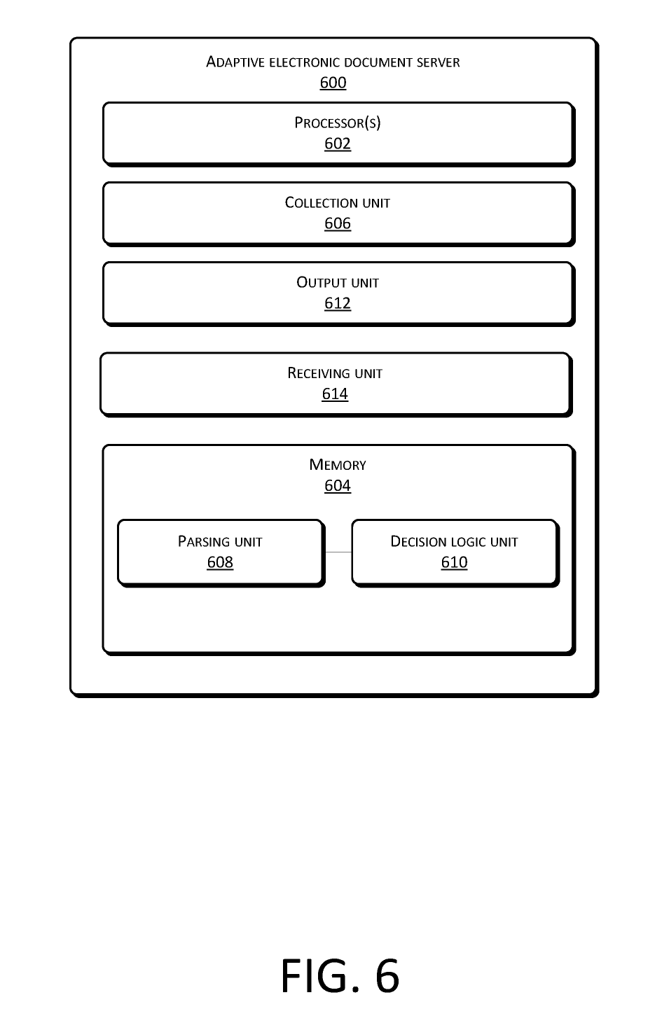

FIG. 6 is a schematic structural diagram of an example adaptive electronic document server 600 according to an example embodiment of the present disclosure. The server 600 may include one or more processor(s) 602 or data processing unit(s) and memory 604. The memory 604 is an example of computer-readable media.

The server 600 may include the following units:

a collection unit 606 that collects application environment information;

an parsing unit 608, stored on memory 604, that parses a decision logic for matching corresponding content with a style corresponding to the content according to different application environments in an electronic document;

a decision logic unit 610, stored on memory 604, that implements the decision logic according to the decision logic and application environment information;

an output unit 612 that sends, according to a result of the decision logic, corresponding content and a style corresponding to the content in the electronic document to a reading terminal for presentation.

According to an example embodiment of the present disclosure, the application environment information collected by the collection unit 602 includes personalized information of a reader.

According to an example embodiment of the present disclosure, the server 600 may further include a receiving unit 614 that receives attribute information of a reading terminal and/or general attributes as the application environment information.

According to an example embodiment of the present disclosure, the personalized information of the reader includes, but is not limited to, age, location, gender, reading preferences, income and the like of the reader; the attribute information of the reading terminal includes, but is not limited to, a type (mobile phone, tablet, or the like), resolution, dimension, computation capability (CPU), storage capability (memory), network type used, interactive support, and the like of the reading terminal; the general attributes include, but are not limited to, date, time, motion status, light, location, and the like.

The above collection unit 606 may be implemented by using a server (common computer or high-performance computer) to collect reader data on a daily basis, and for example, may be a reader information collection unit embedded at a webpage or stored on the memory 604 (which stores information such as daily reading habits of the reader and the type and performance of the reading terminal). The parsing unit 608 and the decision logic unit 610 may be stored on the memory 604 and implemented by the processor(s) 602. The output unit 612 may use a communication device or apparatus of the server 600, for example, a network card, to send the corresponding content and style in the electronic document to the reading terminal. The receiving unit 614 may also use the communication device or apparatus of the server 600.

By using the above adaptive electronic document server of the present disclosure, an electronic document that has particular content and style and is matched with the application environment of the reader is provided to the reader according to the decision logic for the electronic document, which improves the reading experience for the reader. In addition, for on-line readers, implementing a decision logic for an electronic document on a remote server and sending content and style of the electronic document that is matched with the reader to the reading terminal of the reader save the network traffic for the reader, and there is no change or increased cost in terms of the hardware of the reading terminal of the reader.

The adaptive electronic document file structure in the example embodiment of the present disclosure includes a content part and a logic part. The content part includes all the content of an electronic document, for example, all the paragraphs; the logic part includes a decision logic for selecting content and a style for display according to an application environment. For example, if the application environment satisfies a condition, content 1 is displayed in style 1. A corresponding adaptive electronic document file is generated by the adaptive electronic document generation apparatus of the present disclosure.

The above application environment includes personalized information of a reader, for example, gender, age, education level, occupation and job position, income level, geographical location and language, personality traits, consumption habits, recreational activities, interests and hobbies, points of interest, reading preferences, and the like, and social relationships, such as the circle of friends and relatives, the occupational circle and the interest circle. The above information may be entered by the reader during registration, or may be obtained through a mass data analysis and mining based on user behaviors, for example, the purchase and consumption habits of e-commerce websites, information about the friends circle of the user in a social networking website, and the like, and a user identity feature may be matched according to a mobile phone number, a mobile phone hardware identification code, a user login account or the like.

The application environment may further include attribute information of a reading terminal, for example, device type (a tablet, a mobile phone, a TV, or the like), network (on-line, bandwidth, fees, and the like), computation and storage capability (memory, CPU and the like), presentation capability (screen size, color, resolution, refresh rate, and the like), multimedia and interactive support (audio/video format, touch remote control, and the like), application platform of the reading device (Android, IOS, and the like), and the like.

The application environment may further include general attributes, for example, date, time, location, motion status, light, noise, whether it is a public occasion, GPS positioning information, and the like.

The above environment information may be represented by using a parameter. For example, a parameter may be formed by using (abbreviated name of attribute value: attribute value) or (abbreviated name of attribute value: enumerated value). For example, AGE represents the age of the reader, where AGE:18-25 indicates that reader is aged between 18 to 25; INC represents the income of the reader, where INC: 1w-2w indicates that the income range of the reader is between 10 to 20 thousands; SC_SZ represents the resolution of the reading terminal, where SC_SZ:1280_720 indicates that the screen resolution of the reading terminal is 1280*720. With respect to the user consumption preference and purchase history, according to statistics in different dimensions such as frequency of on-line shopping each week, commodity type and commodity price, the range or type is defined as CS_WF:5-10 (5 to 10 times of on-line shopping each week), CS_CT:FOOD (the commodity type is food), and CS_VL:100-200 (the commodity price is 100 to 200).

The above decision logic may be represented by using the above parameter and a decision logic expression. For example, if AGE:18-25 then show #1 else show #2. The above decision logic expression means that if the reader is aged between 18 to 25, the 1^{st} paragraph (which may either be a specific paragraph or a paragraph index) is displayed, otherwise, the 2^{nd} paragraph is displayed.

The above decision logic expression may be written before specific paragraph content of an electronic document, or may be a parameter that independently exists as part of the adaptive electronic document.

The logic part may at least include a decision logic for default content and style, and when the application environment information does not satisfy any decision logic, the default content and style are displayed.

The result of the decision logic is a decision logic branch may be particular content and style in the electronic document. For example, when the screen size is larger than 50 inches (TV), the style of some paragraphs is set to be a column division style, which may further include 3 columns for landscape orientation or 2 columns for portrait orientation.

In case of landscape or portrait orientation, for a full-screen bleed image (that is, the image occupies the whole page with no page margin), different presentation styles will be used, and different sizes and caption positions will be specified; that is, when the directions are consistent, a full-screen display is used and the caption is superimposed on a blank position of the image; when the directions are not consistent, there is an image bleed, and the caption is displayed in a blank area.

For example, when the screen pixel density (Pixels Per Inch, PPI) is greater than 320, the overall scaling ratio that is set in the style is 1.5, that is, content on the page is zoomed in by 1.5 times as a whole.

For example, when a record in an annual income information field of the personalized information of the reader is greater than 100 thousands, the gender is further identified. High-end group-specific advertisements are displayed at particular advertising spaces, while default advertising content is presented for other readers.

For example, when the reading terminal is on-line via Wifi (which may be represented by using 0 or 1), on-line resources such as music and video are inserted at a particular content position.

For example, when the attribute information of the reading terminal includes large screen (such as larger than 5 inches) and on-line via Wifi (which may be represented by using 0 or 1), among the images, there is an on-line high-definition replacement image for download and display.

The above decision logic branch is described for illustration only, and the type and form of various decision logic branches are not limited thereto.

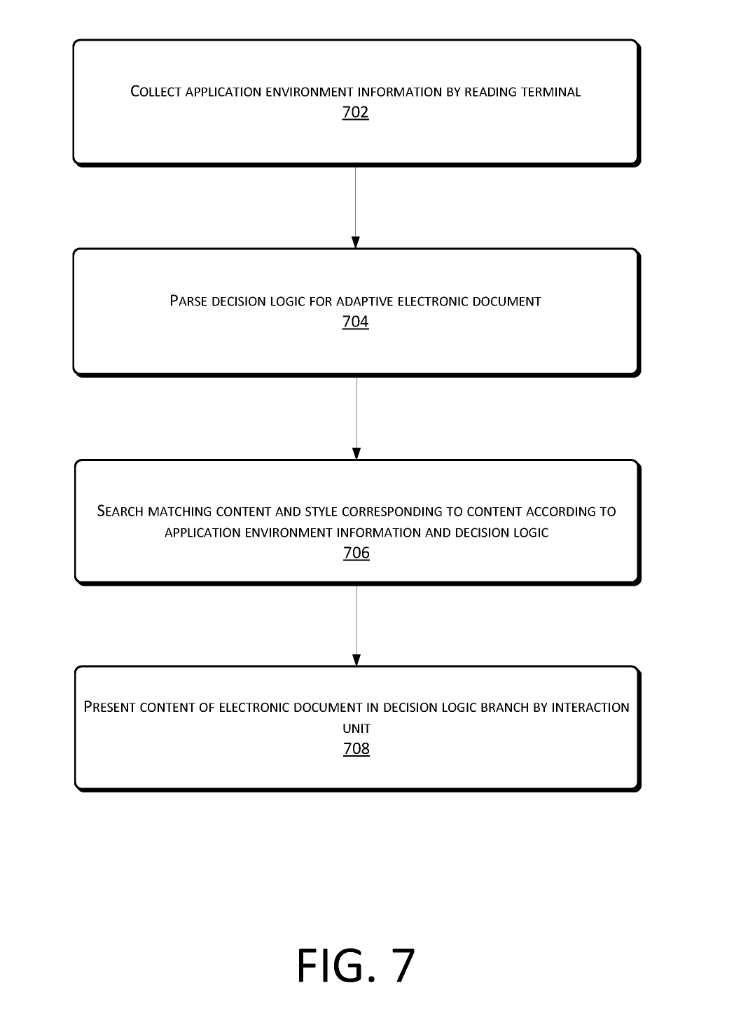

FIG. 7 is a flowchart of example processing an adaptive electronic document by a reading terminal according to an example embodiment of the present disclosure.

When a reader downloads an adaptive electronic document file to a tablet computer, at the tablet computer, the following operations may be performed.

At 702, application environment information is collected by a reading terminal.

The reading terminal in the example embodiment may be a tablet computer. When acquiring general attributes of the tablet computer, a light status in the current reading environment of the reader is collected by a light sensor of the tablet computer, and a current speed of movement of the tablet computer is collected by an acceleration sensor; when acquiring attribute information of the tablet computer, geographical location information is obtained by a GPS on the tablet computer, and the CPU model of the tablet computer and information such as the screen size and resolution of the tablet computer are obtained according to device information of the tablet computer. A user identity feature is matched according to a hardware identification code of the tablet computer or a user login account, and personalized information of the reader, for example, information such as the gender, age, income and reading preferences of the user that is entered during registration of reading software, is further read from a user information server.

All the general attributes of the tablet computer, the attribute information of the tablet computer and the personalized information of the reader in the application environment information are obtained. In other example embodiments of the present disclosure, it is also feasible to obtain only one or more of them as the application environment information.

At 704, a decision logic for an adaptive electronic document is parsed.

The logic part in the adaptive electronic document is parsed by a processor or CPU on the tablet computer, that is, a source file of the adaptive electronic document is parsed and the logic part in the file is extracted.

At 706, according to the application environment information and decision logic, matching content and a style corresponding to the content are searched.

For example, in the example embodiment, a part of content of the electronic document is a psychological test. The decision logic is that if the reader is older than 18 years old, psychological test content that is appropriate for adults over 18 years old is displayed with red as background color, otherwise, psychological test content that is appropriate for minors under 18 is displayed. If the acquired personalized information of the reader in the application environment information is the age of 20 years old, the decision logic is implemented and a corresponding branch is entered to display psychological test content for those over 18 years old with red as background color; if the acquired personalized information of the reader in the application environment information is the age of 16 years old, the decision logic is implemented to display psychological test content for minors.

The above decision logic branch may further include determining whether a current motion stability of the tablet computer (that is, direction, value and change degree of the acceleration in the general attributes) is greater than a predefined threshold, and if so, displaying the content of the electronic document in a large font, otherwise, displaying the content of the electronic document in a small font. In the example embodiment, if the direction and value of the acceleration of the tablet computer collected at 702 continuously change, it indicates that the reader may be in a moving vehicle. Therefore, a large font is used to enable the reader to see the content of the electronic document clearly, or a friendly prompt that informs the user to stop reading is displayed.

The above decision logic branch may further include determining the processing capability of a CPU of the tablet computer. For example, if the processing speed of the CPU of the tablet computer reaches a certain threshold, upon the display of the content of the electronic document, a high-quality rendering enhancement effect is enabled or corresponding accompaniment music is played. Thus, in the example embodiment, if the processing speed of the CPU of the tablet computer acquired at 702 exceeds the threshold, a high-quality rendering enhancement effect is enabled and accompanying music is played upon the display of the content of the electronic document, thereby improving the user experience of the reader.

In this operation, the content and style in the decision logic branch may be real content, that is, an article or paragraph presented in a certain style, or may be an index number (reference identifier) of the content and style, such that the content and style that satisfy the presentation of the decision logic branch 1 are content 1 and style 2 respectively.

At 708, the content of the electronic document in the above decision logic branch is presented by an interaction unit such as a display screen of the tablet computer.

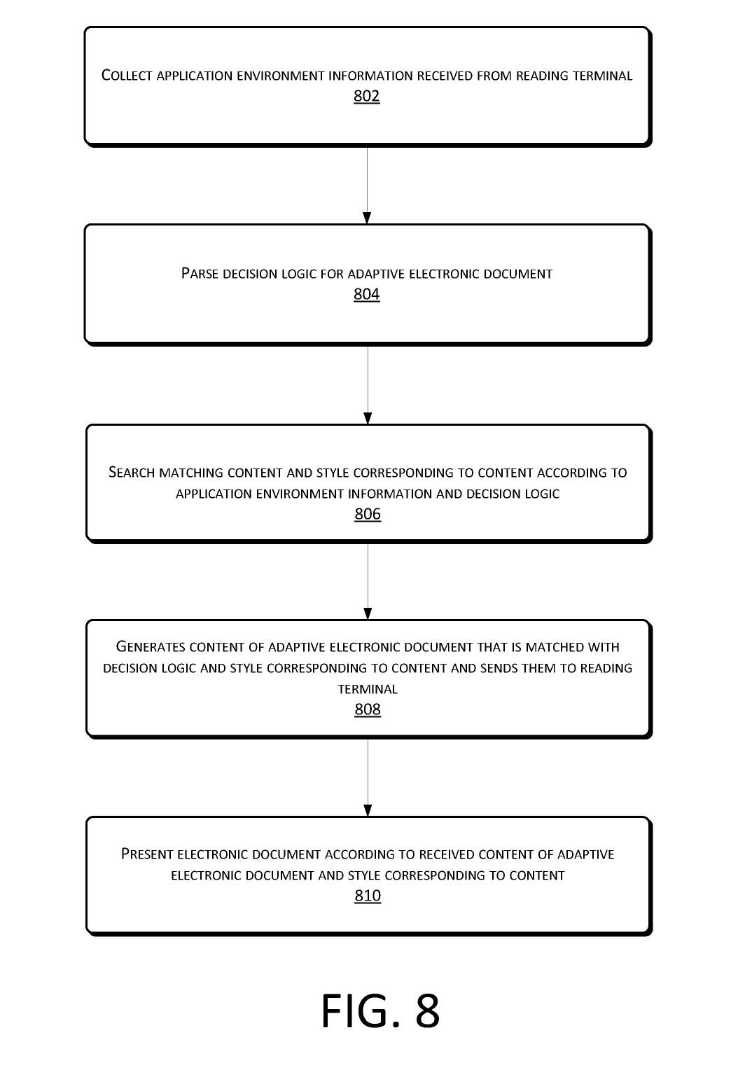

FIG. 8 is a flowchart of example of processing an adaptive electronic document by a server according to an example embodiment of the present disclosure.

Upon the receipt of an adaptive electronic document, the server may provide electronic document content that is matched with reader personality and a style corresponding to the content to a reading terminal of the reader through a client terminal-server communication.

At 802, application environment information of the reader is collected by receiving information sent from the reading terminal.

In the example embodiment, the reading terminal may be a mobile phone. For example, when the mobile phone collecting its own general attributes, a light status in the current reading environment of the reader is collected by a light sensor of the mobile phone, and the current speed of movement is collected by an acceleration sensor; in case of attribute information of the mobile phone, geographical location information is obtained by a GPS on the mobile phone, and the CPU model of the mobile phone, the screen size and resolution and network information are obtained according to device information. A user identity feature is matched according to a hardware identification code of the mobile phone, a user login account, a mobile phone number or the like. The mobile phone transmits the information about the general attributes and the attribute information to the server via a network.

The server acquires personalized information of the reader, for example, information such as the gender, age, income and reading preferences of the user, according to registration information or history record of the reader on the server. The server may also acquire information that is obtained through a mass data analysis and mining based on user behaviors, for example, the purchase and consumption habits of e-commerce websites, information about the friend circle of the user in a social networking website, and the like.

All the general attributes of the mobile phone, the attribute information and the personalized information of the reader in the application environment information are acquired. In other example embodiments of the present disclosure, it is also feasible to acquire only one or more of them as the application environment information.

At 804, the server parses a decision logic for an adaptive electronic document.

The logic part in the adaptive electronic document may be parsed by a processor such as a high-performance CPU on the server, that is, a source file of the adaptive electronic document is parsed and the logic part in the file is extracted.

At 806, according to the application environment information and decision logic, matching content and a style corresponding to the content are searched.

For example, in the example embodiment, a part of content of the electronic document is a psychological test. The decision logic is that if the reader is older than 18 years old, psychological test content that is appropriate for adults over 18 years old is displayed with red as background color, or else, psychological test content that is appropriate for minors under 18 is displayed. If the acquired personalized information of the reader in the application environment information is the age of 20 years old, the decision logic is implemented and enters a corresponding branch to display psychological test content for those over 18 years old with red as background color; if the acquired personalized information of the reader in the application environment information is the age of 16 years old, the decision logic is implemented to display psychological test content for minors.

The above decision logic branch may further include determining whether a network currently used by the mobile phone is a Wifi network. If so, the matching electronic document content is multimedia content such as a high-definition image, otherwise, the electronic document content is a common image or in a text form with a smaller size. In the example embodiment, it is acquired at 802 that the mobile phone uses a Wifi network, and the matching decision logic branch is to transmit multimedia content.

The above decision logic branch may further include determining the processing capability of a CPU of the mobile phone. If the processing speed of the CPU reaches a certain threshold, corresponding accompanying music is played upon the display of the content of the electronic document. Thus, in the example embodiment, if the CPU acquired at 802 exceeds the threshold, accompanying music is played upon the display of the content of the electronic document to improve the user experience of the reader.

In the example embodiment, it may be not necessary for the processor to process all the decision logic branches. For example, a decision logic branch that selects a paragraph according to the date will be left, as a part of the logic part in the adaptive electronic document sent by the server to the mobile phone, for the mobile phone to implement the logical decision.

At 808, the server generates content of the adaptive electronic document content that is matched with the decision logic and a style corresponding to the content and sends them to the reading terminal such as a mobile phone.

At 810, the reading terminal presents the electronic document according to the received content of adaptive electronic document and the style corresponding to the content.

With the method and apparatus of the embodiment of the present disclosure, in the production of an electronic document, different branches are defined according to different application environments and various logical relationships, and in such branches, corresponding content and style are described and presented. When presenting an electronic document, a reading device parses a decision logic, and makes a logic determination according to personalized information of a reader, general attribute and attribute information of a terminal, selects an optimal branch, present the content or present a style according to the content, and present an interaction mode; which solves, to some extent, the problem with the personalized and adaptive reading for different devices, environments and readers in terms of an one-time production and publication of the content of an electronic document, and greatly improves the flexibility and design freedom for electronic document creators, and makes it possible for a reader device to provide a personalized reading service more intelligently and accurately.

In the 1990s, whether a technical improvement is a hardware improvement (for example, an improvement on a circuit structure such as a diode, a transistor, a switch, etc.) or a software improvement (an improvement on a method and process) may be differentiated clearly. However, along with the development of technologies, an improvement on a method or process nowadays may be regarded as a direct improvement on a hardware circuit structure. Almost all the designers program an improved method or process into a hardware circuit to obtain a corresponding hardware circuit structure. Therefore, one of ordinary skill in the art cannot say that an improvement on a method and process cannot be implemented by a hardware entity module. For example, a Programmable Logic Device (PLD) (such as a Field Programmable Gate Array (FPGA)) is such an integrated circuit whose logic function is determined by user's programming. The designers may program by themselves to “integrated” a digital system with a PLD, and there is no need to ask a chip manufacturer to design and manufacture an application-specific integrated circuit chip. Furthermore, instead of manually producing an integrated circuit chip, such a programing is often implemented by “logic compiler” software, which is similar to a software compiler used for program development and coding, and before compiling, original codes may also be written in a particular programming language, which is referred to as a Hardware Description Language (HDL). There is not only one type of HDL but also a plurality of types of HDLs, such as ABEL (Advanced Boolean Expression Language), AHDL (Altera Hardware Description Language), Confluence, CUPL (Cornell University Programming Language), HDCal, JHDL (Java Hardware Description Language), Lava, Lola, MyHDL, PALASM, RHDL (Ruby Hardware Description Language) and the like, among which VHDL (Very-High-Speed Integrated Circuit Hardware Description Language) and Verilog2 are most commonly used nowadays. Those skilled in the art also understand that a hardware circuit for implementing a logic method and process may be easily obtained by programming such a method and process into an integrated circuit with a logical programming and above hardware description languages.

A controller may be implemented in any suitable manner. For example, the controller may use the form of for example a microprocessor or processor and a computer-readable medium that stores computer-readable program code or computer-executable instructions (e.g., software or firmware) executable by the (micro)processor, logic gates, switches, an Application Specific Integrated Circuit (ASIC), a programmable logic controller, and an embedded microcontroller. The examples of controllers include, but are not limited to: ARC 625D, Atmel AT91SAM, Microchip PIC18F26K20, and Silicon Labs C8051F320. The memory controller may also be implemented as part of the memory control logic.

Those skilled in the art also know that, in addition to implementing a controller by pure computer readable programming codes, the operations in the described methods may be logically programmed so that the controller may realize a same function in the form of such as a logic gate, a switch, an application specific integrated circuit, a programmable logic controller, or an embedded microcontroller. Therefore, such a controller may be regarded as a hardware component, and its apparatus for realizing various functions may be regarded as an internal structure of the hardware component. The apparatus for realizing various functions may even be regarded either as a software module for realizing a method or an internal structure of a hardware component.

For example, the system, apparatus, module or unit illustrated in the above embodiment may be implemented by a computer chip or an entity, or a product with a certain function.

For the sake of convenient description, the above apparatuses are functionally divided into various units which are separately described. Certainly, when implementing the present disclosure, the functions of various units may be implemented in one or more instances of software and/or hardware.

By the preceding description of the embodiments, persons skilled in the art may clearly understand that the present disclosure may be implemented via software plus the necessary general hardware platform. Based on such understanding, the substance of the technical solution of the present disclosure, or the portion of the application that makes contribution to the state of the art, may be embodied in the form of a computer software product that is stored in a computer-readable medium, such as ROM/RAM, diskette, CD-ROM, etc. that contains computer-executable instructions enabling a computer device (which may be a personal computer, a server, a network device, and so on) to execute the methods recited in the example embodiments or a portion of the example embodiments of the present disclosure.

The example embodiments in the present disclosure are described in a progressive manner, and for identical or similar parts between different embodiments, reference may be made to each other so that each of the example embodiments focuses on differences from other example embodiments. Especially, the system embodiment is described relatively simply because it is substantially similar to the method embodiments, and for related parts, reference may be made to the method embodiments.

The present disclosure may be used in an environment or configuration of universal or specialized computer systems. Examples include: a personal computer, a server computer, a handheld device or a portable device, a tablet device, a multi-processor system, a microprocessor-based system, a set-up box, a programmable customer electronic device, a network PC, a small-scale computer, a large-scale computer, and a distributed computing environment including any system or device above.

The present disclosure may be described in a general context of computer-executable instructions executed by a computer, such as a program module. Generally, a program module includes routines, programs, objects, modules, and data structure, etc., for executing particular tasks or implementing particular abstract data types. The present disclosure may also be implemented in a distributed computing environment. In the distributed computing environment, a task is executed by remote processing devices which are connected through a communication network. In distributed computing environment, the program module may be stored at computer-readable media (which include storage devices) of local and remote computers.

Although the present disclosure is described with the above example embodiments, one of ordinary skill in the art may alter or modify the present disclosure in many ways without departing from the spirit of the present disclosure. These modifications and variations should be considered to be included in the appended claims without departing from the spirit of the application.

What is claimed is:

1. A method comprising:
producing multiple contents of an electronic document and respective styles, each style corresponding to a respective content of the multiple contents; and
editing a decision logic that matches the respective contents with the respective styles according to different application.

2. The method of claim 1, wherein the editing the decision logic includes editing a parameter that represents a respective application environment.

3. The method of claim 2, wherein the editing the decision logic further includes forming a decision logic expression by using the parameter.

4. The method of claim 3, wherein the decision logic expression includes a logic branch that includes a reference identifier that represents the respective content and the respective style.

5. The method of claim 3, wherein the decision logic expression includes a logic branch that includes specific data of the respective content with the respective style.

6. A method comprising:
collecting application environment information;
parsing a decision logic that matches a respective content with a respective style of different styles according to different application environments in an electronic document;
implementing the decision logic according to the decision logic and the collected application environment information; and
presenting, according to a result of the decision logic, the respective content and the respective style corresponding to the respective content in the electronic document.

7. The method of claim 6, wherein the application environment information includes personalized information of a reader.

8. The method of claim 7, wherein the personal information includes:
an age of the reader;
a location of the reader;
a gender of the reader;
a reading preference of the reader; or
an income of the reader.

9. The method of claim 6, wherein the application environment information includes attribute information of a reading terminal.

10. The method of claim 9, wherein the attribute information of the reading terminal includes:
a type of the reading terminal;
a resolution of the reading terminal;
a dimension of the reading terminal;
a computation capability of the reading terminal;
a storage capability of the reading terminal;
a network type used by the reading terminal; or
an interactive support of the reading terminal.

11. The method of claim 6, wherein the application environment information includes general attributes of a scenario that the reading terminal resides.

12. The method of claim 11, wherein the general attributes include:
a date;
a time;
a motion status of a reading terminal;
a light environment where the reading terminal is located; or
a location where the reading terminal is located.

13. The method of claim 6, wherein the application environment information is collected by a reading terminal.

14. The method of claim 13, wherein the reading terminal includes a mobile phone or a tablet.

15. The method of claim 6, wherein the parsing the decision logic is conducted by a reading terminal.

16. The method of claim 6, wherein the parsing the decision logic is conducted by a server.

17. A reading terminal comprising:
a collection unit that collects application environment information;
a parsing unit that parses a decision logic that matches a respective content with a respective style of different styles according to different application environments in an electronic document;
a decision logic unit that implements the decision logic according to the decision logic and the collected application environment information; and
a presentation unit that presents, according to a result of the decision logic, the respective content and the respective style corresponding to the respective content in the electronic document.

18. The reading terminal of claim 17, wherein the collection unit includes a sensor of the reading terminal.

19. The reading terminal of claim 17, wherein the present unit includes a display screen of the reading terminal.

20. The reading terminal of claim 17, wherein the application environment information includes:
personalized information of a reader of the reading terminal;
attribute information of the reading terminal; and
general attributes of a scenario that the reading terminal resides.
